(19) United States
(12) Patent Application Publication
(10) Pub. No.: US 2005/0129037 A1
(43) Pub. Date: Jun. 16, 2005

(54) Ring interface unit

(75) Inventors: Philip J. Zumsteg, Shorewood, MN (US); Kevin R. Driscoll, Maple Grove, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc., Morristown, NJ (US)

(21) Appl. No.: 10/993,928

(22) Filed: Nov. 19, 2004

Related U.S. Application Data
(60) Provisional application No. 60/523,839, filed on Nov. 19, 2003.

(51) Int. Cl. H04L 12/40; H04L 12/28

(52) U.S. Cl. 370/404; 370/406

(57) ABSTRACT

In one embodiment, a network comprises a plurality of linear bus nodes and a plurality of ring interface units. Each of the linear bus nodes is communicatively coupled to each of a plurality of rings using at least one of the plurality of ring interface units. In another embodiment, a network comprises a ring and a plurality of nodes. Each of the plurality of nodes is adapted to communicate data over a linear bus. The network further comprises a plurality of ring interface units. Each of the ring interface units communicatively couples a respective node to the ring.

### CROSS REFERENCE TO RELATED APPLICATIONS

This application is related to and claims the benefit of the filing date of U.S. Provisional Application No. 60/523,839, filed on Nov. 19, 2003, which is incorporated herein by reference.

### TECHNICAL FIELD

The following description relates to communication systems in general and to distributed, fault-tolerant systems in particular.

### BACKGROUND

Distributed, fault-tolerant communication systems are typically used in applications where a failure could possibly result in injury or death to one or more persons. Such applications are referred to here as “safety-critical applications.” One example of a safety-critical application is in a system that is used to monitor and manage sensors and actuators included in an airplane or other aerospace or ground-based vehicle.

In aerospace and other vehicular applications, it is typically desirable to minimize the weight and cost of such a distributed, fault-tolerant system. Classical fault tolerant communication architectures (for example, triple modular redundancy or quad redundancy architectures) incur significant weight and cost penalties in such fault-tolerant systems beyond an individual chassis or equipment bay due to the additional cost and/or additional weight of the redundant communication paths provided in such architectures.

One architecture that is commonly considered for use in aerospace applications is the Time-Triggered Architecture (TTA). In a TTA system, multiple nodes communicate with one another over two replicated high-speed communication channels using, for example, the Time Triggered Protocol/C (TTP/C). In some embodiments, at least one of the nodes in such a TTA system is coupled to one or more sensors and/or actuators over two replicated, low-speed serial communication channels using, for example, the Time Triggered Protocol/A (TTP/A). The TTA, TTP/C, and TTP/A are described in specifications promulgated by TTTech Computertechnik AG.

Typically, in a TTA system, multiple nodes are networked together using a communication network having a star topology or a bus topology in accordance with the TTP/C protocol. Similarly, a node and the sensors and/or actuators with which that node communicates are networked together using a linear bus topology in accordance with the TTP/A protocol. Although a network having a star topology (also referred to here as a “star network”) provides multiple, redundant data paths, a star network typically requires an order of magnitude more wiring to implement, which increases the cost and weight of such a star network as the distances between the nodes increase. A network having a linear bus topology (also referred to here as a “linear bus topology”) typically requires significantly less wire to implement than a star network. However, a linear bus network is susceptible to single points of failure, which may not be suitable for some safety-critical applications that require high reliability.

### SUMMARY

In one embodiment, an apparatus comprises a node adapted to communicate data over a plurality of linear buses and a ring interface unit, in communication with the node, to communicatively couple the node to a plurality of rings.

In another embodiment, an apparatus comprises a linear bus node and a ring interface unit to communicatively couple the linear bus node to a plurality of rings.

In another embodiment, a network comprises a plurality of nodes. Each of the plurality of nodes is adapted to communicate data over a plurality of linear buses. The network further comprises a plurality of ring interface units. Each of the ring interface units communicatively couples a respective node to a plurality of rings.

In another embodiment, a network comprises a plurality of linear bus nodes and a plurality of ring interface units. Each of the linear bus nodes is communicatively coupled to each of a plurality of rings using at least one of the plurality of ring interface units.

In another embodiment, an apparatus comprises a node adapted to communicate data over a linear bus and a ring interface unit, in communication with the node, to communicatively couple the node to a ring.

The details of one or more embodiments of the claimed invention are set forth in the accompanying drawings and the description below. Other features and advantages will become apparent from the description, the drawings, and the claims.

### DRAWINGS

FIG. 1 is a high-level block diagram of one embodiment of a communication network.

FIG. 2 is a block diagram of one embodiment of a master node that is suitable for use in the network of FIG. 1.

FIG. 3 is a block diagram of one embodiment of a slave node that is suitable for use in network of FIG. 1.

FIG. 4 is a block diagram of one embodiment of a ring interface unit.

FIGS. 5A-5C are block diagrams illustrating the operation of the embodiment of ring interface unit shown in FIG. 4.

FIG. 6 is a block diagram illustrating how the network of FIG. 1 handles a single fault.

FIG. 7 is a block diagram illustrating how the network of FIG. 1 handles two faults.

FIG. 8 is a block diagram illustrating how the network of FIG. 1 handles two faults.

FIG. 9 is a block diagram illustrating how the network of FIG. 1 handles a “babbling idiot” type fault.

FIG. 10 is a block diagram of one embodiment of a peer-to-peer network.

FIG. 11 is a block diagram of an exemplary embodiment of a simplex network.

Like reference numbers and designations in the various drawings indicate like elements.

### DETAILED DESCRIPTION

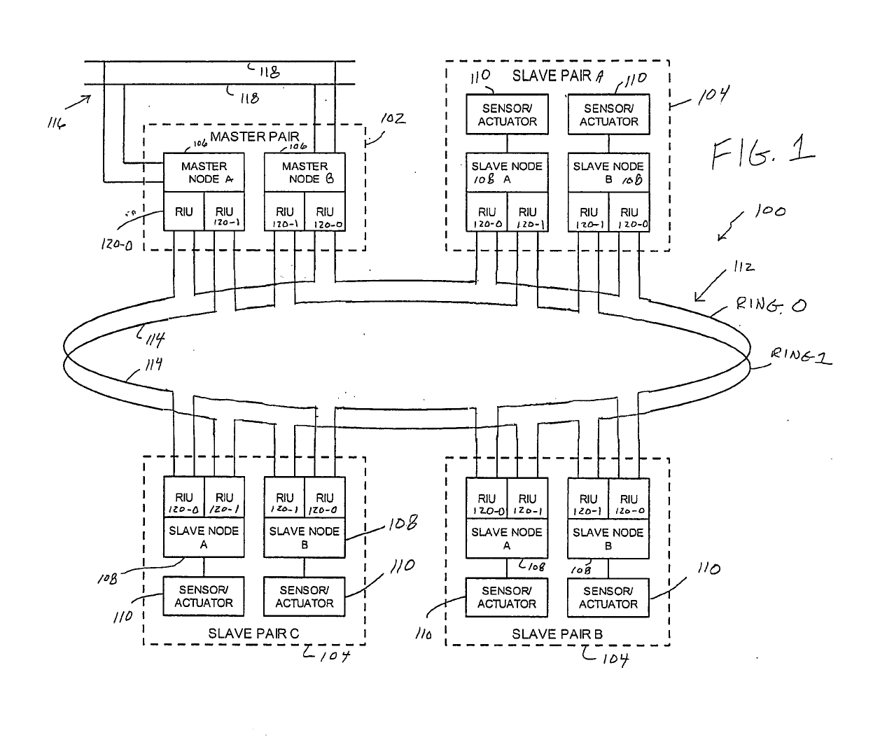

FIG. 1 is a high-level block diagram of one embodiment of a communication network 100. Embodiments of network 100 are suitable for use in, with, or as a distributed, fault-tolerant system used in a safety-critical application (for example, in aerospace or automotive applications). In the embodiment shown in FIG. 1, the network 100 is implemented using the master-slave TTP/A protocol architecture. The network 100 includes one master node pair 102 (also referred to here as the “master pair” 102) and multiple slave node pairs 104 (also referred to here as “slave pairs” 102). In the embodiment shown in FIG. 1, there are three slave node pairs 104 (individually labeled as “slave pair A”, “slave pair B”, and “slave pair C”) that communicate with the master pair 102 over the network 100. In other embodiments, other numbers of subsystems are used.

In the embodiment shown in FIG. 1, each node pair 102 and 104 includes two redundant nodes. In other embodiments, the functionality performed by one or more of the node pairs 102 and/or 104 in the network 100 is implemented with a different number of nodes (for example, using a single node or three or more nodes). The master pair 102 includes two master nodes 106. The master nodes 106 are referred to here individually as “master node A” and “master node B,” respectively. Each master node 106 implements the communication and control functionality specified in the TTP/A specification for a master node. In one implementation, one of the master nodes 106 is designated as the primary master node and, when able to do so, performs the master-node processing for the network 100. In such an implementation, the other master node 106 is designated as the secondary or backup master node 106. While the primary master node is performing the master-node processing for the network 100 (also referred to here as operating in an “active” mode), the secondary master node 106 operates in a “shadow” mode in which the secondary master node 106 monitors the communications in the network 100 so that the secondary master node 106 is able to quickly takeover performing the master-node processing for the network 100 in the event that the primary master node is unable to so. In other implementations, other dual-redundancy schemes are used.

Each of the slave pairs 104 includes two slave nodes 108. The slave nodes 108 of each slave pair 108 are referred to here individually as “slave node A” and “slave node B,” respectively. Each slave node 108 implements the communication and control functionality specified in the TTP/A specification for a slave transducer node. Each slave node A and B of each slave pair 104 is coupled to at least one transducer 110. The at least one transducer 110 includes, for example, at least one sensor and/or actuator. In the embodiment shown in FIG. 1, each slave pair 104 includes two redundant transducers 110, with one transducer 110 (also referred to here as “transducer A”) coupled to slave node A and the other transducer 110 (also referred to here as “transducer B”) coupled to slave node B. The master node pair 102 (more specifically, the master nodes A and B) communicates with the slave pair 104 (more specifically, slave nodes A and B) in order to receive information detected by a sensor (where the transducer 110 includes a sensor) and/or to actuate an actuator (where the transducer 110 includes an actuator). In such an implementation, the communication of data (for example, in the form of frames) between the master node pair 102 and the slave node pairs 104 is done in accordance with the TTP/A protocol.

In one implementation of the embodiment shown in FIG. 1, for each slave pair 104, one of the slave nodes 108 is designated as the primary slave node and, when able to do so, performs the slave-node processing for that slave pair 104. In such an implementation, the other slave node for each slave subsystem 104 is designated as the secondary or backup slave node. While the primary slave node for a given slave pair 104 is performing the slave-node processing for that slave pair 104 (also referred to here as operating in an “active” mode), the secondary slave node operates in a “standby” mode in which the secondary slave node monitors the communications in the network 100 so that the secondary slave node is able to quickly takeover performing the slave-node processing for that slave pair 104 in the event that the primary slave node is unable to so. In other implementations, other dual-redundancy schemes are used.

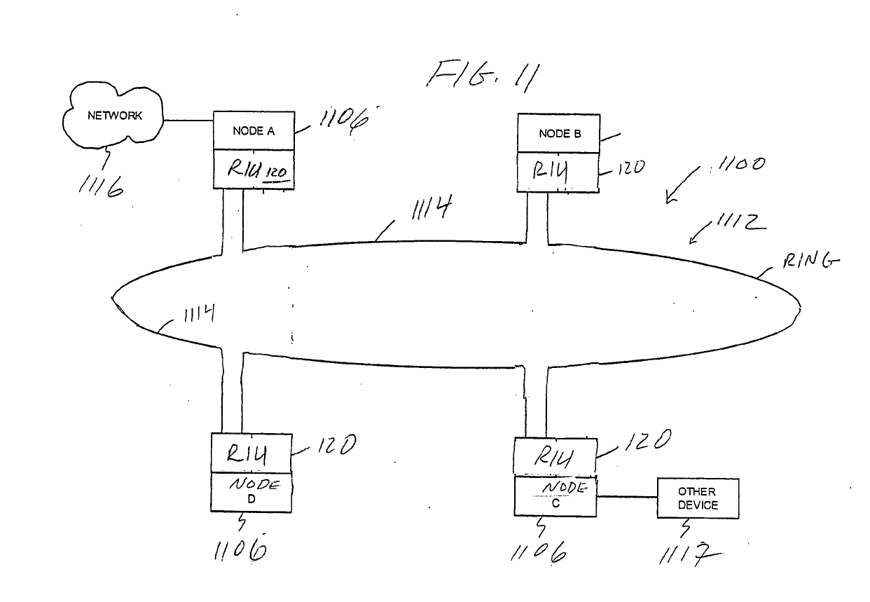

The master pair 102 communicates with the slave subsystems 104 over two communication channels 112. Each of the communication channels 112 is implemented as a ring that includes multiple, bi-directional serial links 114 that connect each node to that node's two neighbor nodes. The two channels 112 are also referred to here individually as “channel 0” or “ring 0” and “channel 1” or “ring 1”, respectively. For example, as shown in FIG. 1, a link 114 that is a part of ring 0 couples master node A to master node B in the clockwise direction and another link 114 that is a part of ring 0 couples the master node A to slave node A of slave pair C in the counter-clockwise direction. Although two rings are shown in FIG. 1, it is to be understood that in other embodiments, more or less rings are used (for example, one ring is used in the embodiment shown in FIG. 11).

In the particular embodiment shown in FIG. 1, the nodes 106 and 108 are implemented using TTP/A linear bus components. That is, each of the nodes 106 and 108 are implemented using TTP/A component that are typically used to couple a TTP/A node to one or more linear buses. In the particular embodiment shown in FIG. 1, each node 106 and 108 is adapted to communicate over four linear buses. Each linear bus node is coupled to the rings using a pair of ring interface units 120. For each such linear bus node, one ring interface unit 120 (referred to here individually as a ring interface unit 120-0) couples the node to the ring 0 and the other ring interface unit (referred to here individually as a ring interface unit 120-1) couples the node to the ring 1. In this way, TTP/A linear bus components can be used in the dual ring bus topology of FIG. 1. More generally, ring interface units 120 can be used to implement a ring bus topology (or similar topologies) using linear bus components not otherwise designed for use in such topologies in order to improve the integrity and/or reliability that can be realized using such linear bus components.

Although each ring interface unit 120 is shown in FIG. 1 as being separate from the corresponding node, in other embodiments the ring interface unit 120 is integrated into to the corresponding node (for example, where TTP/A interface components directly supports the ring bus topology of network 100). Also, in other embodiments, the functionality described here as a being performed by a pair of ring interface units 120-0 and 120-1 for a given linear bus node is implemented using a single ring interface unit.

Each master node 106 also acts as a gateway to a second, upper-layer network 116 (a TTP/C network 116, in the embodiment shown in FIG. 1). The master nodes 106 communicate with nodes (not shown in FIG. 1) in the network 116 over two, replicated high-speed channels 118. For example, in one implementation of such an embodiment, the network 116 is implemented using a bus topology or a star topology and the high-speed channels 118 are implemented using a local-area network protocol such as the ETHERNET network protocol.

In operation, when one of the nodes 106 and 108 in the embodiment of network 100 shown in FIG. 1 (referred to here as the “transmitting node”) transmits data (for example, in the form of one or more frames of data) to the other nodes in the network 100, the transmitting node transmits the same data along four separate data paths. In the particular embodiment shown in FIG. 1, which is implemented using the TTP/A protocol, the nodes in the network 100 transmit in accordance with an agreed-upon time-division multiple access (TDMA) schedule. The transmitting node transmits data in both the clockwise and counter-clockwise directions around ring 0 and in both the clockwise and counter-clockwise directions around ring 1. In such an embodiment, for each transmission by a node, one of the other nodes in the network is designated as the “terminal” or “destination” node for that transmission. The transmitting node and the designated terminal node “break” the rings 0 and 1. Each of the other nodes in the network 100 (that is, the nodes other than the transmitting node and the terminal node) acts as a repeater and forwards any data received at that node onto the next node in the network 100 along the same ring on which the data was received.

In one example, the master node A is the transmitting node and slave node A of slave pair B is the terminating node for that transmission. In such an example, master node A transmits, via the ring interface unit 120-0 coupled thereto, in both a clockwise and counter-clockwise direction along ring 0 and transmits, via the ring interface unit 120-1, in a both a clockwise and counter-clockwise direction along ring 1. Data transmitted in a counter-clockwise direction along ring 0 from master node A is first received by the ring interface unit 120-0 coupled to slave node A of slave pair C, which forwards the received data along ring 0 in a counter-clockwise direction to slave node B of slave pair C. The ring interface unit 120-0 also forwards the received data to slave node A of slave pair C for TTP/A protocol processing thereby. The ring interface unit 120-0 coupled to slave node B of slave pair C receives the data from ring 0 and forwards the received data along ring 0 in a counter-clockwise direction to slave node A of slave pair B. The ring interface unit 120-0 also forwards the received data to slave node B of slave pair C for TTP/A protocol processing thereby. The ring interface unit 120-0 coupled to slave node A of slave pair B receives the data from ring 0. Because the slave node A of slave pair B is the terminating node in this example, the ring interface unit 120-0 coupled to that node does not forward the received data any further along ring 0 in the counter-clockwise direction. The ring interface unit 120-0 coupled to slave node A of slave pair B forwards the received data to slave node A of slave pair B for TTP/A protocol processing thereby.

Similar processing occurs in the counter-clockwise direction along ring 1. Data transmitted in a counter-clockwise direction along ring 1 from master node A is first received by the ring interface unit 120-1 coupled to slave node A of slave pair C, which forwards the received data along ring 1 in a counter-clockwise direction to slave node B of slave pair C. The ring interface unit 120-1 also forwards the received data to slave node A of slave pair C for TTP/A protocol processing thereby. The ring interface unit 120-1 coupled to slave node B of slave pair C receives the data from ring 1 and forwards the received data along ring 1 in a counter-clockwise direction to slave node A of slave pair B. The ring interface unit 120-1 also forwards the received data to slave node B of slave pair C for TTP/A protocol processing thereby. The ring interface unit 120-1 coupled to slave node A of slave pair B receives the data from ring 1. Because the slave node A of slave pair B is the terminating node in this example, the ring interface unit 120-1 coupled to that node does not forward the received data any further along ring 1 in the counter-clockwise direction. The ring interface unit 120-1 coupled to slave node A of slave pair B forwards the received data to slave node A of slave pair B for TTP/A protocol processing thereby.

Data transmitted in a clockwise direction along ring 0 from master node A is first received by the ring interface unit 120-0 coupled to master node B, which forwards the received data along ring 0 in a clockwise direction to slave node A of slave pair A. The ring interface unit 120-0 also forwards the received data to master node B for TTP/A protocol processing thereby. The ring interface unit 120-0 coupled to slave node A of slave pair A receives the data from ring 0 and forwards the received data along ring 0 in a clockwise direction to slave node B of slave pair A. The ring interface unit 120-0 also forwards the received data to slave node A of slave pair A for TTP/A protocol processing thereby. The ring interface unit 120-0 coupled to slave node B of slave pair A receives the data from ring 0 and forwards the received data along ring 0 in a clockwise direction to slave node B of slave pair B. The ring interface unit 120-0 also forwards the received data to slave node B of slave pair A for TTP/A protocol processing thereby. The ring interface unit 120-0 coupled to slave node B of slave pair B receives the data from ring 0 and forwards the received data along ring 0 in a clockwise direction to slave node A of slave pair B. The ring interface unit 120-0 also forwards the received data to slave node B of slave pair B for TTP/A protocol processing thereby. The ring interface unit 120-0 coupled to slave node A of slave pair B receives the data from ring 0. Because the slave node A of slave pair B is the terminating node in this example, the ring interface unit 120-0 coupled to that node does not forward the received data any further along ring 0 in the clockwise direction. The ring interface unit 120-0 coupled to slave node A of slave pair B forwards the received data to slave node A of slave pair B for TTP/A protocol processing thereby.

Similar processing occurs in the clockwise direction along ring 1. Data transmitted in a clockwise direction along ring 1 from master node A is first received by the ring interface unit 120-1 coupled to master node B, which forwards the received data along ring 1 in a clockwise direction to slave node A of slave pair A. The ring interface unit 120-1 also forwards the received data to master node B for TTP/A protocol processing thereby. The ring interface unit 120-1 coupled to slave node A of slave pair A receives the data from ring 1 and forwards the received data along ring 1 in a clockwise direction to slave node B of slave pair A. The ring interface unit 120-1 also forwards the received data to slave node A of slave pair A for TTP/A protocol processing thereby. The ring interface unit 120-1 coupled to slave node B of slave pair A receives the data from ring 1 and forwards the received data along ring 1 in a clockwise direction to slave node B of slave pair B. The ring interface unit 120-1 also forwards the received data to slave node B of slave pair A for TTP/A protocol processing thereby. The ring interface unit 120-1 coupled to slave node B of slave pair B receives the data from ring 1 and forwards the received data along ring 1 in a clockwise direction to slave node A of slave pair B. The ring interface unit 120-1 also forwards the received data to slave node B of slave pair B for TTP/A protocol processing thereby. The ring interface unit 120-1 coupled to slave node A of slave pair B receives the data from ring 1. Because the slave node A of slave pair B is the terminating node in this example, the ring interface unit 120-0 coupled to that node does not forward the received data any further along ring 1 in the clockwise direction. The ring interface unit 120-1 coupled to slave node A of slave pair B forwards the received data to slave node A of slave pair B for TTP/A protocol processing thereby.

As a result when data is transmitted from the transmitting node (master node A in this example), the data is transmitted along four data paths—a clockwise data path along the ring 0, a counter-clockwise data path along the ring 0, a clockwise data path along the ring 0, and a counter-clockwise data path along the ring 1. If there are no faults in the network 100, the terminal node (slave node A of slave pair B in this example) receives four instances of the data transmitted by the transmitting node (one from each of the four data paths) and, in this embodiment, the received data should all be the same. The four separate data paths increase the reliability and redundancy of communications between the nodes of the network 100. For example, network 100 shown in FIG. 1, with the four separate data paths, is able to tolerate one Byzantine fault.

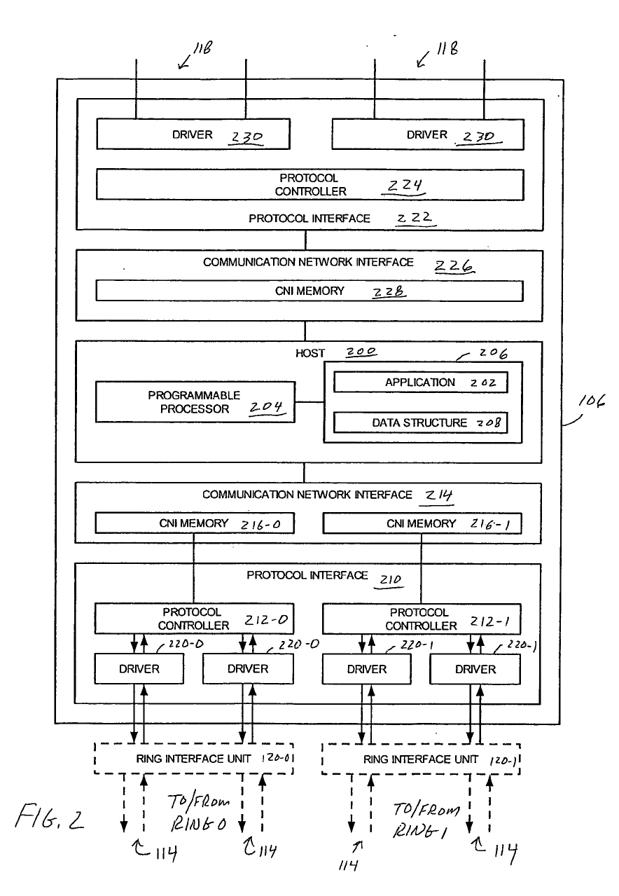

FIG. 2 is a block diagram of one embodiment of a master node 106 that is suitable for use in the network 100 shown in FIG. 1. Master node 106 includes a host 200 that executes an application 202. The application 202 that implements the high-level functionality of the master node 106. In the embodiment shown in FIG. 2, the host 200 is implemented using a programmable processor 204 that executes the application 202. The host 200, in such an embodiment, includes memory 206 for storing the application 202 and data structures 208 used by the application 202. For example, in one implementation of such an embodiment, the application 202 is a control application that monitors and/or controls a subsystem of a vehicle such as a subsystem that controls and/or monitors the doors in an airplane. In such an implementation, the transducers 110 coupled to the slave nodes 108 are used to monitor and/or control the doors in the airplane.

The master node 106 includes a protocol interface 210 through which the host 200 communicates data to and from the master node 106 and the slave nodes 108 over the channels 112 of network 100 using an appropriate communication protocol. The protocol interface 210 includes multiple protocol controllers 212 that implement the particular communication protocol supported by the protocol interface 210. In the embodiment shown in FIG. 2, two protocol controllers 212 are used in each master node 106. One of the protocol controllers 212 is used to communicate over ring 0 and is referred to here as “protocol controller” 212-0. The other protocol controller 212 is used to communicate over ring 1 and is referred to here as “protocol controller” 212-1. In the embodiment shown in FIG. 2, the protocol controllers 212 implement the TTP/A protocol (though other protocols are used in other embodiments). In this embodiment, the protocol interface 210 is also referred to here as a “TTP/A protocol interface” 210 and the protocol controllers 212 are referred to here as “TTP/A protocol controllers” 212. Each TTP/A protocol controller 212, in one implementation, includes a programmable processor (not shown in FIG. 2) that is programmed with appropriate program instructions to implement the TTP/A protocol.

The protocol interface 210 also includes a communication network interface (CNI) 214 that serves as an interface between the host 200 and the protocol controllers 212. In the embodiment shown in FIG. 2, the CNI 214 includes multiple dual-ported memories 216 (also referred to here as “CNI memories” 216). One CNI memory 216 is used to couple the host 200 to the protocol controller 212-0 using appropriate address, data, and control buses and lines (not shown in FIG. 2). This CNI memory 216 is referred to here individually as “CNI memory” 216-0. The host 200 reads from and writes to the CNI memory 216-0 using one port and the protocol controller 212-0 reads from and writes to the CNI memory 216-0 using the other port. The other CNI memory 216 is used to couple the host 200 to the protocol controller 212-1 using appropriate address, data, and control buses and lines (not shown in FIG. 2) and is referred to here individually as “CNI memory” 216-1. The host 200 reads from and writes to the CNI memory 216-1 using one port and the protocol controller 212-1 reads from and writes to the CNI memory 216-1 using the other port. In one implementation of such an embodiment, each CNI memory 216 is implemented using a dual-ported static random access memory (SRAM) (though other types of memory are used in other embodiments and implementations).

In the particular embodiment shown in FIG. 2, the master node 106 includes drivers 220 that are designed for providing a physical-layer interface between the protocol controllers 212 and a pair of linear buses. However, when used in the network 100 which makes use of dual rings, the node 106 is coupled to the dual rings using the ring interface units 120. When used in the network 100, a pair of drivers 220 is coupled to a respective ring interface unit 120 that, in turn, couples the master node 106 to a respective ring of the network 100. In the embodiment shown in FIG. 2, one pair of drivers 220 (each of which is individually identified in FIG. 2 using the reference numeral “220-0”) couples the protocol controller 212-0 to the ring interface unit 120-0. The other pair of drivers 220 (each of which is individually identified in FIG. 2 using the reference numeral “220-1”) couples the protocol controller 212-1 to the ring interface unit 120-1. In one implementation, the drivers 220 are implemented using universal asynchronous receiver/transmitters (UARTs).

The application 202 executing on the host 200 also communicates with nodes of the high-level network 116 of FIG. 1 through a higher-level protocol interface 222 using an appropriate communication protocol. The higher-level protocol interface 222 includes a higher-level protocol controller 224 that implements the particular communication protocol supported by the protocol interface 222. In the embodiment shown in FIG. 2, the higher-level protocol controller 224 implements the TTP/C protocol (though other protocols are used in other embodiments). In this embodiment, the protocol interface 222 is also referred to here as the “TTP/C protocol interface” 222 and the protocol controller 224 is referred to here as the “TTP/C protocol controller” 224. The TTP/C protocol controller 224, in one implementation, includes a programmable processor (not shown in FIG. 2) that is programmed with appropriate program instructions to implement the TTP/C protocol.

The protocol interface 222 also includes a second communication network interface (CNI) 226 that serves as an interface between the host 200 and the protocol controller 224. In the embodiment shown in FIG. 2, the CNI 226 includes a dual-ported memory 228 (also referred to here as a “CNI memory” 228). The CNI memory 228 is used to couple the host 200 to the protocol controller 224 using appropriate address, data, and control buses and lines (not shown in FIG. 2). The host 200 reads from and writes to the CNI memory 228 using one port and the protocol controller 224 reads from and writes to the CNI memory 228 using the other port. In one implementation of such an embodiment, the CNI memory 228 is implemented using a dual-ported static random access memory (SRAM) (though other types of memory are used in other embodiments and implementations).

A pair of drivers 230 serves as a physical-layer interface between the TTP/C protocol controller 224 and the higher-speed channels 118 of FIG. 1. In one implementation, the drivers 230 are implemented using ETHERNET physical-layer devices.

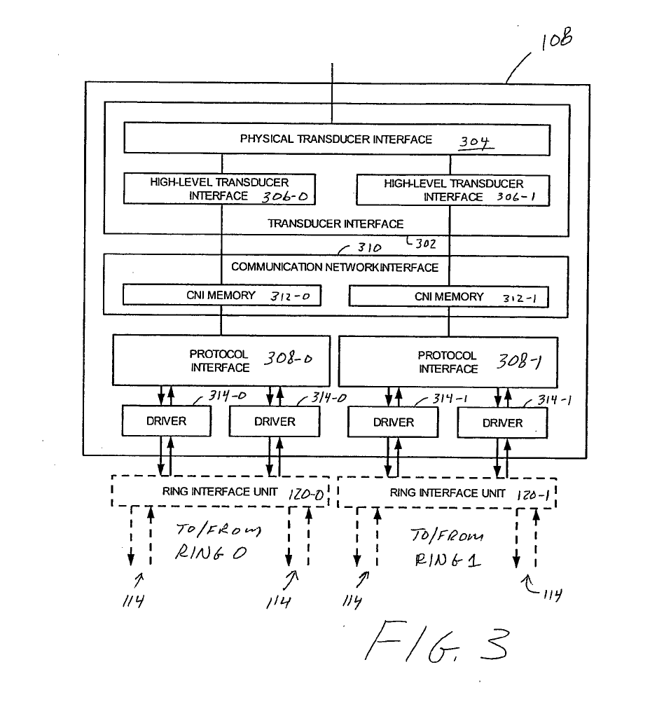

FIG. 3 is a block diagram of one embodiment of a slave node 108 that is suitable for use in the network 100 shown in FIG. 1. Each slave node 108 includes a transducer interface 302 that allows the slave node 108 to communicate with the at least one transducer 110 to which that slave node 108 is coupled. In the particular embodiment shown in FIG. 3, the transducer interface 302 includes a physical transducer interface 304 that provides the physical interface and connection between the transducer 110 and the slave node 108. Also, in the embodiment shown in FIG. 3, the transducer interface 302 includes a high-level transducer interface 306 that implements the control and/or monitoring functionality for the type of transducer 110 coupled to the physical transducer interface 306 and interacts with a communication network interface 310 (described below). In the embodiment shown in FIG. 3, a separate high-level transducer interface 306 is provided for each of the channels 112 (that is, rings 0 and 1) over which the master nodes 106 communicate with that slave node 108. That is, one high-level transducer interface 306 is provided for channel 0 (referred to here individually as “high-level transducer interface” 306-0) and another high-level transducer interface 306 is provided for channel 1 (referred to here individually as “high-level transducer interface” 306-1).

The slave node 108 also includes a protocol interface 308 that communicates data between the transducer interface 302 and the master nodes 106 over channels 112. In the embodiment shown in FIG. 3, a separate protocol interface 308 is provided for each channel 112. That is, one protocol interface 308 (referred to here individually as “protocol interface” 308-0) communicates with channel 0 and another protocol interface 308 (referred to here individually as “protocol interface” 308-1) communicates with channel 1. In the embodiment shown in FIG. 3, the protocol interfaces 308 implement the TTP/A slave protocol.

A communication network interface (CNI) 310 serves as an interface between the high-level transducer interfaces 306 and the protocol interfaces 308. In the embodiment shown in FIG. 3, the CNI 310 is implemented using multiple memories 312 (also referred to here as “CNI memories” 312). One CNI memory 312 is used to couple the high-level transducer interface 306-0 and the protocol interface 308-0 to one another. This CNI memory 312 is referred to here individually as “CNI memory 312-0”). Another CNI memory 312 is used to couple the high-level transducer interface 306-1 and the protocol interface 308-1 to one another. This CNI memory 312 is referred to here individually as “CNI memory 312-1”).

In the embodiment shown in FIG. 3, the high-level transducer interface 306-0 and the protocol interface 308-0 are implemented by programming a programmable processor (not shown) with appropriate program instructions to carry out the functionality described here as being performed by the high-level transducer interface 306-0 and the protocol interface 308-0. The high-level transducer interface 306-1 and the protocol interface 308-1 are implemented by programming another programmable processor (not shown) with appropriate program instructions to carry out the functionality described here as being performed by the high-level transducer interface 306-1 and the protocol interface 308-1. In such an embodiment, each of the CNI memories 312 is implemented using a separate memory device. In one implementation of such an embodiment, each CNI memory 312 is implemented using memory integrated within a respective programmable processor. In another implementation of such an embodiment, each CNI memory 312 is implemented using an external memory device that is coupled to a respective programmable processor using appropriate address, data, and control buses and lines.

In the particular embodiment shown in FIG. 3, the slave node 108 includes drivers 314 that are designed for providing a physical-layer interface between the protocol interfaces 308 and a pair of linear buses. However, when used in the network 100 which makes use of dual rings, the node 108 is coupled to the dual rings using the ring interface units 120. When used in the network 100, a pair of drivers 314 is coupled to a respective ring interface unit 120 that, in turn, couples the slave node 108 to a respective ring of the network 100. In the embodiment shown in FIG. 3, one pair of drivers 314 (each of which is individually identified in FIG. 3 using the reference numeral “314-0”) couples the protocol interface 308-0 and the ring interface unit 120-0. The other pair of drivers 314 (each of which is individually identified in FIG. 2 using the reference numeral “314-1”) couples the protocol interface 308-1 and the ring interface unit 120-1. In one implementation, the drivers 314 are implemented using universal asynchronous receiver/transmitters (UARTs).

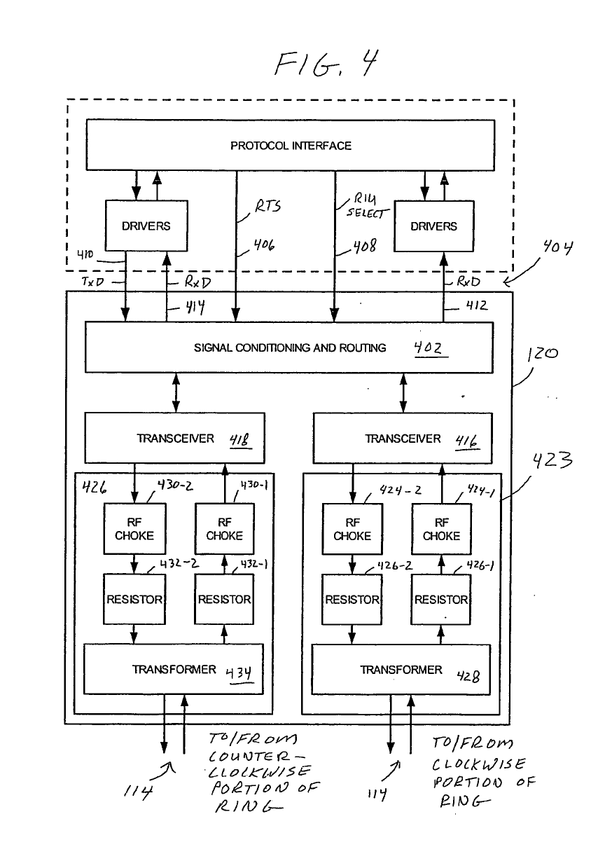

FIG. 4 is a block diagram of one embodiment of a ring interface unit 120. Embodiments of ring interface unit 120 are suitable for use in the nodes 106 and 108 shown in FIGS. 2 and 3, respectively. The ring interface unit 120 includes a signal condition and routing module 402 that couples the ring interface unit 120 to the respective drivers and protocol interface of the node in which the ring interface unit 120 is included.

An interface 404 between the ring interface 120 and the drivers and protocol interface includes a ready-to-transmit (RTS) line 406 that the protocol interface asserts when the protocol interface is ready to transmit data on the ring coupled to the ring interface unit 120 (also referred to in the context of FIG. 4 simply as the “ring”). The interface 404 also includes a ring interface unit (RIU) select line 408 that the protocol interface asserts to indicate to the ring interface unit 120 that the respective protocol interface wishes to receive or transmit data (that is, not act as a repeater). The interface 404 also includes a transmit data (TxD) line 410 on which a driver supplies, in serial form, data to be transmitted by the ring interface unit 120 on the ring. The interface 404 further includes first and second receive data (RxD) lines 412 and 414 on which data received by the ring interface unit 120 from the ring is supplied, in serial form, to the drivers to which the ring interface unit 120 is coupled. For example, the first receive data line 412 supplies, to a respective driver, data received from the clockwise portion of the ring (relative to the ring interface unit 120) and the second receive data line 414 supplies, to a respective driver, data received from the counter-clockwise portion of the ring.

The ring interface unit 120 includes first and second transceivers 416 and 418 that receive and transmit signals from and to first and second links 114, respectively, of the ring to which the ring interface unit 120 is coupled. The signal conditioning and routing module 402 routes signals between the drivers and the first and second transceivers 416 and 418. The ring interface unit 120 includes a first and second line interface units 423 and 426 that couple the first and second transceivers 416 and 418, respectively, to the first and second links 114, respectively, of the particular ring to which the ring interface unit 120 is coupled. In the embodiment shown in FIG. 4, the first and second links 114 to which the ring interface unit 120 is coupled (and that couple the various nodes together) are implemented using two-wire links (for example, using copper twisted-pair cable).

In the embodiment shown in FIG. 4, the first line interface unit 423 includes radio frequency (RF) chokes 424-1 and 424-2 in series with bias resistors 426-1 and 426-2, respectively, for impedance matching and a transformer 428 that couples the first transceiver 416 to the first link 114. Similarly, in the embodiment shown in FIG. 4, the second line interface unit 426 includes RF chokes 430-1 and 430-2 in series with bias resistors 432-1 and 432-2, respectively, for impedance matching and a transformer 434 that couples the second transceiver 418 to the second link 114.

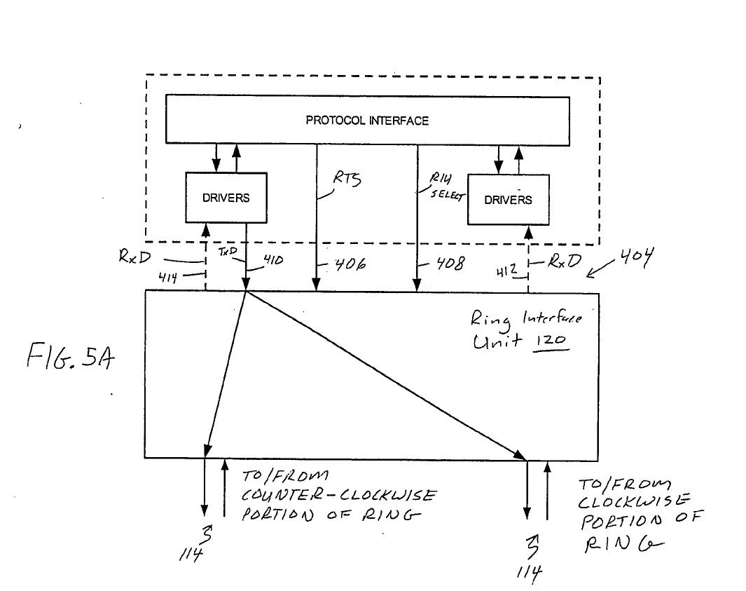

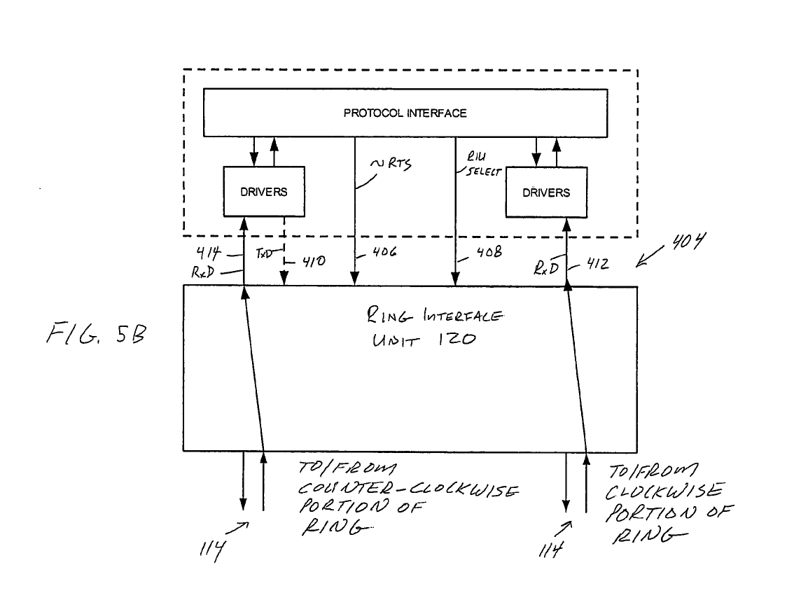

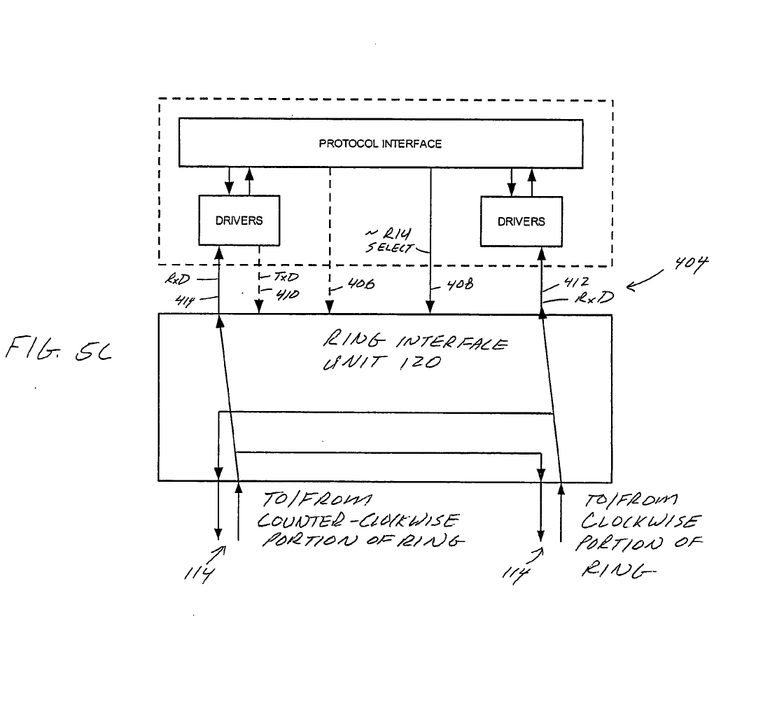

FIGS. 5A-5C are block diagrams illustrating the operation of the embodiment of ring interface unit 120 shown in FIG. 4. FIG. 5A illustrates the operation of ring interface unit 120 while in a transmitter mode (that is, when the node of which the ring interface unit 120 is a part is transmitting on the ring). The protocol interface to which the ring interface unit 120 is coupled puts the ring interface unit 120 into transmitter mode by asserting the RIU select line 408 and the RTS line 406. Then, the data to be transmitted is supplied from a driver to which the ring interface unit 120 on the transmit data line 410. The signal conditioning and routing module 402 (not shown in FIG. 5A) routes the data received on the transmit data line 410 to the first and second transceivers 416 and 418 (not shown in FIG. 5A), which transmit the data out on the first and second lines 114, respectively.

FIG. 5B illustrates the operation of a ring interface unit 120 while in a receiver mode (that is, when the node of which the ring interface unit 120 is receiving data from the ring). The protocol interface to which the ring interface unit 120 is coupled puts the ring interface unit 120 into receiver mode by asserting the RIU select line 408 while de-asserting the RTS line 406. Then, the transceiver 416 (not shown in FIG. 5B) receives data from the first link 114 and the transceiver 418 (not shown in FIG. 5B) receives data from the second link 114. The signal conditioning and routing module 402 (not shown in FIG. 5B) routes the received data to respective drivers over the first and second receive data lines 412 and 414.

FIG. 5C illustrates the operation of ring interface unit 120 while in a repeater mode (that is, when the node of which the ring interface unit 120 is a part is neither transmitting nor receiving data on or from the ring). The protocol interface to which the ring interface unit 120 is coupled puts the ring interface unit 120 into repeater mode by de-asserting the RIU select line 408 (regardless of the state of the RTS select line 406). While in the repeater mode, when data is received from the first link 114 by the first transceiver 416 (not shown in FIG. 5C), the signal conditioning and routing module 402 (not shown in FIG. 5C) routes the received data to the second transceiver 418 (not shown in FIG. 5C). The second transceiver 418 transmits the frame out on the second link 422. When data is received from the second link 114 by the second transceiver 418, the signal conditioning and routing module 402 routes the received data to the first transceiver 416. The first transceiver 416 transmits the data out on the first link 114. The signal conditioning and routing module 402 also supplies the received data to the drivers over the first and second receive data lines 412 and 414.

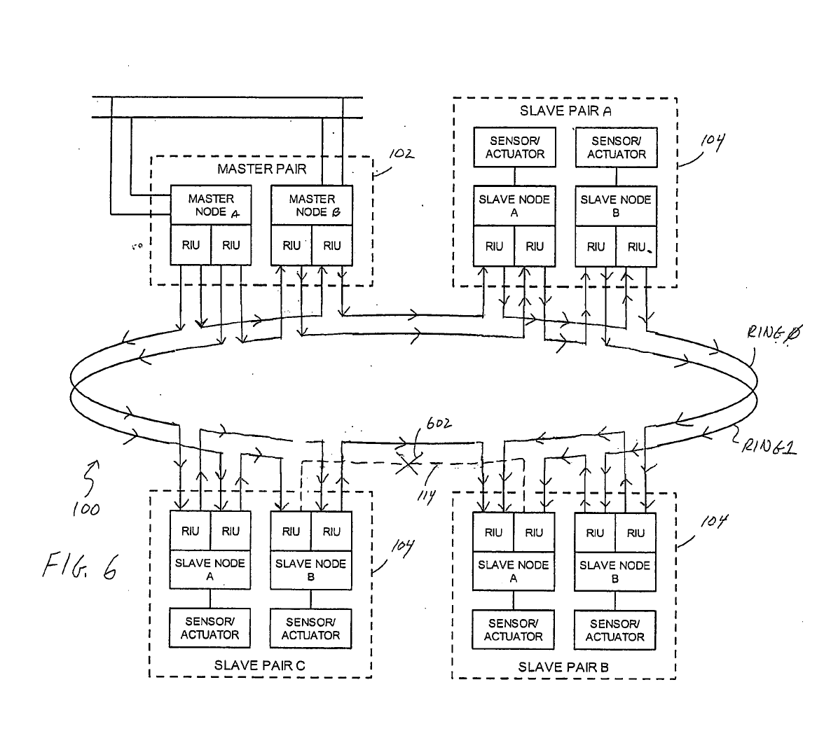

FIG. 6 is a block diagram illustrating how the network 100 of FIG. 1 handles a single fault. In the example shown in FIG. 6, the link 114 included in ring 1 between the slave node A of the slave pair B and the slave node B of slave pair C (shown using a dashed line in FIG. 6) has a fault 602 that prevents data from traveling between the slave node A of the slave pair B and the slave node B of slave pair C over that link 114. As with the example described above, in the example shown in FIG. 6, the master node A is the transmitting node and slave node A of slave pair B is designated as the terminal node.

As a result of the fault 602, data transmitted from the master node A in the clockwise direction along ring 1 is not received at the slave node A of slave pair B. However, slave node A of slave pair B is nevertheless still able to receive the data transmitted from the master node A in a counter-clockwise direction along ring 1. Also, slave node A of slave pair B is still able to receive the data transmitted from the master node A in both a clockwise and counter-clockwise direction along ring 0.

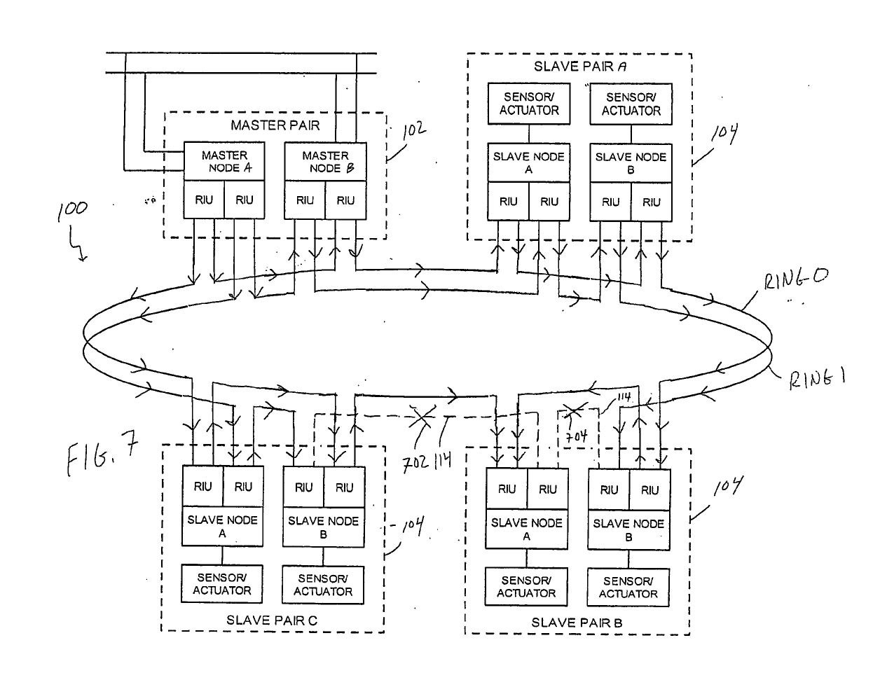

FIG. 7 is a block diagram illustrating how the network 100 of FIG. 1 handles two faults. In the example shown in FIG. 7, the link 114 included in ring 1 between slave node A of slave pair B and slave node B of slave pair C (shown in FIG. 7 using a dashed line) has a fault 702 that prevents data from traveling between slave node B of slave pair C and slave node A of slave pair B over that link 114. Also, in this example, the link 114 included in ring 1 between slave node A of slave pair B and the slave node B of slave pair B (shown in FIG. 7 using a dashed line) has a fault 704 that prevents data from traveling between the slave node B of slave pair B and the slave node A of slave pair B over that link 114. As with the examples described above, in the example shown in FIG. 7, the master node A is the transmitting node and slave node A of slave subsystem B is designated as the terminal node.

As a result of the first fault 702, data transmitted from the master node A in the counter-clockwise direction along ring 1 is not able to be received at slave node A of slave pair B. As a result of the second fault 704, data transmitted from the master node A in the clockwise direction along ring 1 is not able to be received by slave node A of slave pair B. However, slave node A of slave pair B is nevertheless still able to receive the data transmitted from the master node A in both clockwise and counter-clockwise directions along ring 0.

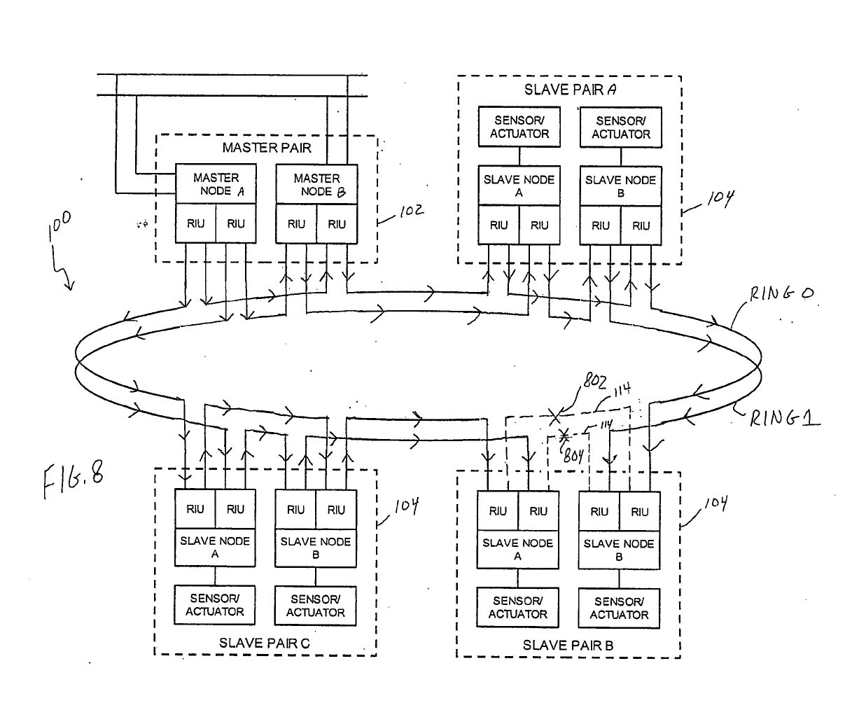

FIG. 8 is a block diagram illustrating how the network 100 of FIG. 1 handles two faults. In the example shown in FIG. 8, the link 114 included in ring 0 between the slave node A of slave pair B and the slave node B of slave pair B (shown in FIG. 8 using a dashed line) has a fault 802 that prevents data from traveling between the slave node B of slave pair B and the slave node A of slave pair B over that link 114. Also in this example, the link 114 included in ring 1 between the slave node A of slave pair B and the slave node B of slave pair B (shown in FIG. 8 using a dashed line) has a fault 804 that prevents data from traveling between the slave node A of slave pair B and the slave node B of slave pair B over that link 114. As with the examples described above, in the example shown in FIG. 8, the master node A is the transmitting node and slave node A of slave pair B is designated as the terminal node. As a result of the first fault 402 and the second fault 404, data transmitted from the master node A in the clockwise direction along both rings 0 and 1 is not able to be received slave node A of slave pair B. However, slave node A of slave pair B is nevertheless still able to receive the data transmitted from master node A in a counter-clockwise direction along both rings 0 and 1.

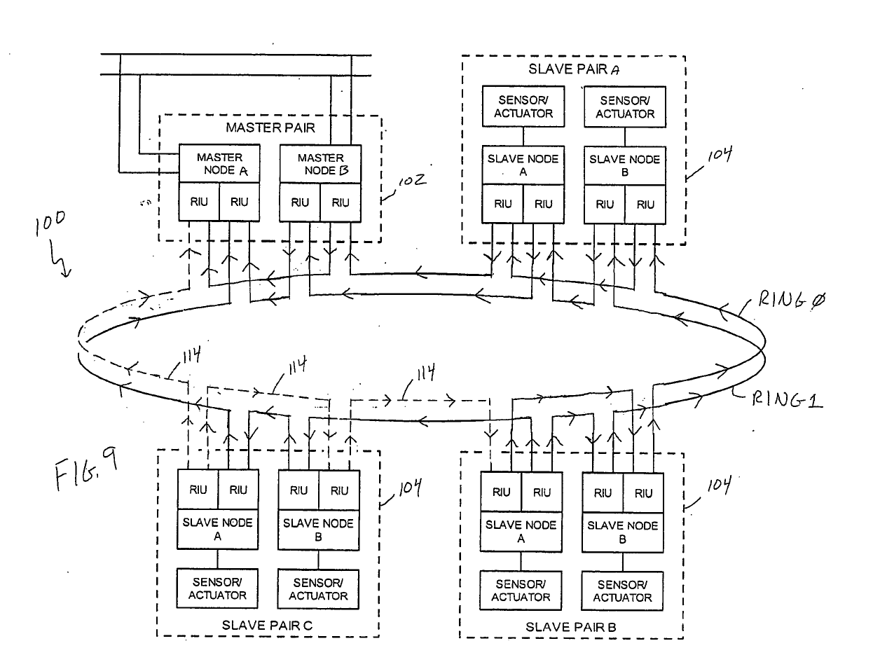

FIG. 9 is a block diagram illustrating how the network 100 of FIG. 1 handles a “babbling idiot” type fault. A babbling idiot fault occurs when a node transmits on one of the rings 0 and 1 when that node is not scheduled to transmit or transmits all the time on that ring. In the example shown in FIG. 9, slave node A of the slave pair B is scheduled to transmit at that time (that is, slave node A of slave pair B is the transmitting node in this example) and master node A is designated as the terminal node. Also in the example shown in FIG. 9, slave node A of slave pair C has a babbling idiot fault that causes slave node A of slave pair C to transmit on ring 0 when the slave node A of slave pair B is scheduled to transmit. That is, while slave node A of slave pair B transmits, slave node A of slave pair C also transmits in both the clockwise and counter-clockwise directions along ring 0.

Because slave node A of slave pair C has a babbling idiot fault with respect to ring 0, slave node A of slave pair C transmits faulty data (that is, data originating from slave node A of slave pair C instead of from slave node A of slave pair B) on ring 0 in a clockwise direction to master node A. Because master node A is a terminal node, master node A does not forward the faulty data received from the slave node A of slave pair C any further on ring 0. Also, because slave node A of slave pair C has a babbling idiot fault with respect to ring 0, slave node A of slave pair C transmits faulty data on ring 0 in a counter-clockwise direction to slave node B of slave pair C. Slave node B of slave pair C then forwards that data on ring 0 to slave node A of slave pair B. Because slave node A of slave pair B is the transmitting node, slave node A of slave pair B does not forward the faulty data received from the slave node B of slave pair C any further on ring 0. More specifically, because the ring interface units 120-0 and 120-1 of slave node A of slave pair B are operating in the transmitting mode illustrated in FIG. 5A, slave node A of slave pair B does not receive any data transmitted by slave node A of slave pair C. Instead of forwarding any faulty data, slave node A of slave pair B transmits valid data (that is, data originating from slave node A of slave pair B) on both rings 0 and 1 in both directions. The transmission of faulty data by the slave node A of slave pair C, however, interferes with the ability of slave node A of slave pair B to transmit valid data along the links 114 (shown using dashed lines in FIG. 9) over which such faulty data travels.

Despite the babbling idiot fault, master node A is able to receive valid data transmitted by the slave node A of the slave pair B. Master node A receives valid data transmitted by slave node A of the slave pair B in a clockwise direction on ring 1. Master node A also receives valid data transmitted by slave node A of slave pair B in a counter-clockwise direction on both rings 0 and 1.

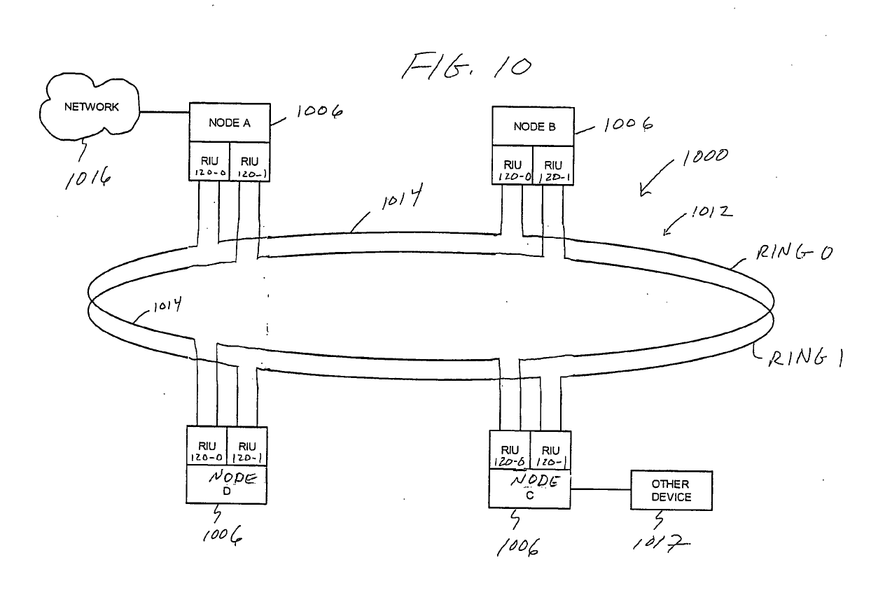

Although the embodiment of network 100 shown in FIG. 1 is described here as being implemented using the master-slave protocol of the TTP/A protocol, it is to be understood that the systems, devices, methods and techniques described here, in other embodiments and implementations, are implemented in other ways, for example, using other network topologies and/or protocols and/or, for example, other numbers of nodes and/or rings. For example, one such other embodiment is illustrated in FIG. 10.

FIG. 10 is a block diagram of an exemplary embodiment of a peer-to-peer network 1000. In the embodiment shown in FIG. 10, the network 1000 is implemented as a peer-to-peer network in which each of a plurality of nodes 1006 are “peers.” In the particular embodiment shown in FIG. 10, the network 1000 includes four nodes 1006 (individually labeled “node A”, “node B”, “node C”, and “node D” in FIG. 10). In other embodiments, other numbers of nodes 1006 are used.

Each of the nodes 1006 communicates with the other nodes 1006 of the network 1000 over two communication channels 1012. Each of the communication channels 1012 is implemented as a ring that includes multiple, bi-directional serial links 1014 that connect each node 1006 to that node's two neighbor nodes. The two channels 1012 are also referred to here individually as “channel 0” or “ring 0” and “channel 1” or “ring 1”, respectively. For example, as shown in FIG. 10, a link 1014 that is a part of ring 0 couples node A to node B in the clockwise direction and another link 1014 that is a part of ring 0 couples node A to node D in the counter-clockwise direction.

In the particular embodiment shown in FIG. 10, the nodes 1006 are implemented using linear bus components. That is, each of the nodes 1006 is implemented using components that are typically used to couple such a node to one or more linear buses. In the particular embodiment shown in FIG. 10, each node 1006 is adapted to communicate over four linear buses. Each linear bus node is coupled to the rings using a pair of ring interface units 120 of the type described above in connection with FIGS. 1-5C. For each such linear bus node, one ring interface unit 120 (referred to here individually as ring interface unit 120-0) couples the node to ring 0 and the other ring interface unit 120 (referred to here individually as ring interface unit 120-1) couples the node to ring 1. In this way, linear bus components can be used in the dual ring bus topology of FIG. 10 (for example, to improve the integrity and/or reliability that can be realized using such linear bus components).

Although each ring interface unit 120 is shown in FIG. 10 as being separate from the corresponding node, in other embodiments each ring interface unit 120 is integrated into to the corresponding node. Also, in other embodiments, the functionality described here as a being performed by a pair of ring interface units 120-0 and 120-1 for a given linear bus node is implemented using a single ring interface unit.

In the embodiment shown in FIG. 10, at least a subset of the nodes 1006 of the network 1000 are coupled to other devices or networks. For example, as shown in FIG. 10, node A is communicatively coupled to a separate network 1016. In this example, node A serves as a gateway between the network 1000 and the network 1016. Also, in this example, node C is communicatively coupled to another device 1017 (for example, a transducer such as a sensor and/or an actuator or any other type of device) using, for example, a point-to-point communication link.

In operation, when one of the nodes 1006 in the embodiment of network 1000 shown in FIG. 10 (referred to here as the “transmitting node”) transmits data (for example, in the form of one or more frames of data) to the other nodes 1006 in the network 100, the transmitting node transmits the same data along four separate data paths. The transmitting node transmits data in both the clockwise and counter-clockwise directions around ring 0 and in both the clockwise and counter-clockwise directions around ring 1. The transmissions from each transmitting node are intended to be received and processed by each of the other nodes in the peer-to-peer network 1000.

In such an embodiment, for each transmission by a node, one of the other nodes in the network is designated as the “terminal” node for that transmission. The transmitting node and the designated terminal node “break” the rings 0 and 1. Each of the other nodes in the network 1000 (that is, the nodes other than the transmitting node and the terminal node) acts as a repeater and forwards any data received at that node onto the next node in the network 1000 along the same ring on which the data was received.

In one example, node A is the transmitting node and node C is the terminating node for that transmission. In such an example, node A transmits, via the ring interface unit 120-0 coupled thereto, in both a clockwise and counter-clockwise direction along ring 0 and transmits, via the ring interface unit 120-1, in a both a clockwise and counter-clockwise direction along ring 1.

Data transmitted in a clockwise direction along ring 0 from node A is first received by the ring interface unit 120-0 coupled to node B. The ring interface unit 120-0 coupled to node B forwards the received data to node B for processing thereby and forwards the received data along ring 0 in a clockwise direction to node C. The ring interface unit 120-0 coupled to node C forwards the received data to node C for processing thereby. Because node C is the terminating node in this example, the ring interface unit 120-0 coupled to that node does not forward the received data any further along ring 0 in the clockwise direction.

Similar processing occurs in the clockwise direction along ring 1. Data transmitted in a clockwise direction along ring 1 from node A is first received by the ring interface unit 120-1 coupled to node B. The ring interface unit 120-1 coupled to node B forwards the received data to node B for processing thereby and forwards the received data along ring 1 in a clockwise direction to node C. The ring interface unit 120-1 coupled to node C forwards the received data to node C for processing thereby. Because node C is the terminating node in this example, the ring interface unit 120-1 coupled to that node does not forward the received data any further along ring 1 in the clockwise direction.

Data transmitted in a counter-clockwise direction along ring 0 from node A is first received by the ring interface unit 120-0 coupled to node D. The ring interface unit 120-0 coupled to node D forwards the received data to node D for processing thereby and forwards the received data along ring 0 in a counter-clockwise direction to node C. The ring interface unit 120-0 coupled to node C forwards the received data to node C for processing thereby. Because node C is the terminating node in this example, the ring interface unit 120-0 coupled to that node does not forward the received data any further along ring 0 in the counter-clockwise direction.

Similar processing occurs in the counter-clockwise direction along ring 1. Data transmitted in a counter-clockwise direction along ring 1 from node A is first received by the ring interface unit 120-1 coupled to node D. The ring interface unit 120-1 coupled to node D forwards the received data to node D for processing thereby and forwards the received data along ring 1 in a counter-clockwise direction to node C. The ring interface unit 120-1 coupled to node C forwards the received data to node C for processing thereby. Because node C is the terminating node in this example, the ring interface unit 120-1 coupled to that node does not forward the received data any further along ring 1 in the counter-clockwise direction.

FIG. 11 is a block diagram of an exemplary embodiment of a network 1100. In the embodiment shown in FIG. 11, the network 1100 is implemented as a “simplex” network in which each of a plurality of nodes 1106 are communicatively coupled to one another over a single channel 1112. Moreover, the network 1100 shown in FIG. 11 is described here as being a peer-to-peer network, though it is to be understood that other approaches could be used (for example, a master-slave network). In the particular embodiment shown in FIG. 10, the network 1100 includes four nodes 1106 (individually labeled “node A”, “node B”, “node C”, and “node D” in FIG. 11). In other embodiments, other numbers of nodes 1106 are used.

The communication channel 1112 is implemented as a ring that includes multiple, bi-directional serial links 1114 that connect each node 1106 to that node's two neighbor nodes. For example, as shown in FIG. 10, a link 1114 that is a part of the ring couples node A to node B in the clockwise direction and another link 1014 that is a part of the ring couples node A to node D in the counter-clockwise direction.

In the particular embodiment shown in FIG. 11, the nodes 1106 are implemented using linear bus components. That is, each of the nodes 1006 is implemented using components that are typically used to couple such a node to one or more linear buses. In the particular embodiment shown in FIG. 11, each node 1106 is adapted to communicate over two linear buses. Each linear bus node is coupled to the ring using a ring interface unit 120 of the type described above in connection with FIGS. 1-5C. In this way, linear bus components can be used in the ring bus topology of FIG. 11 (for example, to improve the integrity and/or reliability that can be realized using such linear bus components).

Although each ring interface unit 120 is shown in FIG. 10 as being separate from the corresponding node, in other embodiments each ring interface unit 120 is integrated into to the corresponding node.

In the embodiment shown in FIG. 11, at least a subset of the nodes 1106 of the network 1100 are coupled to other devices or networks. For example, as shown in FIG. 11, node A is communicatively coupled to a separate network 1116. In this example, node A serves as a gateway between the network 1100 and the network 1116. Also, in this example, node C is communicatively coupled to another device 1117 (for example, a transducer such as a sensor and/or an actuator or any other type of device) using, for example, a point-to-point communication link.

In operation, when one of the nodes 1106 in the embodiment of network 1000 shown in FIG. 11 (referred to here as the “transmitting node”) transmits data (for example, in the form of one or more frames of data) to the other nodes 1106 in the network 1100, the transmitting node transmits the same data along two separate data paths. The transmitting node transmits data in both the clockwise and counter-clockwise directions around the ring. The transmissions from each transmitting node are intended to be received and processed by each of the other nodes in the peer-to-peer network 1100.

In such an embodiment, for each transmission by a node, one of the other nodes in the network is designated as the “terminal” node for that transmission. The transmitting node and the designated terminal node “break” the rings. Each of the other nodes in the network 1100 (that is, the nodes other than the transmitting node and the terminal node) acts as a repeater and forwards any data received at that node onto the next node in the network 1000 along the ring.

In one example, node A is the transmitting node and node C is the terminating node for that transmission. In such an example, node A transmits, via the ring interface unit 120 coupled thereto, in both a clockwise and counter-clockwise direction along the ring.

Data transmitted in a clockwise direction along the ring from node A is first received by the ring interface unit 120 coupled to node B. The ring interface unit 120 coupled to node B forwards the received data to node B for processing thereby and forwards the received data along the ring in a clockwise direction to node C. The ring interface unit 120 coupled to node C forwards the received data to node C for processing thereby. Because node C is the terminating node in this example, the ring interface unit 120 coupled to that node does not forward the received data any further along the ring in the clockwise direction.

Data transmitted in a counter-clockwise direction along the ring from node A is first received by the ring interface unit 120 coupled to node D. The ring interface unit 120 coupled to node D forwards the received data to node D for processing thereby and forwards the received data along the ring in a counter-clockwise direction to node C. The ring interface unit 120 coupled to node C forwards the received data to node C for processing thereby. Because node C is the terminating node in this example, the ring interface unit 120 coupled to that node does not forward the received data any further along the ring in the counter-clockwise direction.

The systems, devices, methods and techniques described here may be implemented in digital electronic circuitry, or with a programmable processor (for example, a special-purpose processor or a general-purpose processor such as a computer) or other programmable devices such as a field programmable gate array (FPGA) or a complex programmable logic device (CPLD), firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

1. An apparatus comprising:
a node adapted to communicate data over a linear bus; and
a ring interface unit, in communication with the node, to communicatively couple the node to a ring.

2. The apparatus of claim 1, wherein the node is adapted to communicative over a plurality of buses and wherein the ring interface unit communicatively couples the node to a plurality of rings.

3. The apparatus of claim 1, wherein the ring interface unit communicatively couples the node to the ring instead of the linear bus.

4. The apparatus of claim 1, wherein the ring interface unit communicatively couples the node to the ring by communicatively coupling the node to first and second portions of the ring.

5. The apparatus of claim 4, wherein when the node transmits data, the ring interface unit communicates the data over the first and second portions of the ring.

6. The apparatus of claim 4, wherein when the node is receiving data, the ring interface unit receives data from the first and second portions of the rings and forwards the received data to the node.

7. The apparatus of claim 4, wherein the ring interface unit receives data on the first portion of the ring and transmits the received data onto the second portion of the ring.

8. The apparatus of claim 1, wherein the ring interface unit comprises:
a first transceiver for communicating data over a first portion of the ring; and
a second transceiver for communicating data over a second portion of the ring.

9. The apparatus of claim 8, wherein the ring interface unit further comprises:
a first line interface unit for coupling the first transceiver to the first portion of the ring; and
a second line interface unit for coupling the second transceiver to the second portion of the ring.

10. The apparatus of claim 1, wherein the ring interface unit is integrated into the node.

11. An apparatus comprising:
a node adapted to communicate data over a linear bus; and
a ring interface unit, in communication with the node, to communicatively couple the node to a ring.

12. The apparatus of claim 11, wherein the ring interface unit communicatively couples the node to the plurality of rings instead of the plurality of linear buses.

13. The apparatus of claim 11, wherein the ring interface unit communicatively couples the node to each of the plurality of rings by communicatively coupling the node to first and second portions of each ring.

14. The apparatus of claim 13, wherein when the node transmits data, the ring interface unit communicates the data over the first and second portions of each of the plurality of rings.

15. The apparatus of claim 13, wherein when the node is receiving data, the ring interface unit receives data from the first and second portions of each of the plurality rings and forwards the received data to the node.

16. The apparatus of claim 13, wherein the ring interface unit receives data on a first portion of each of the plurality of rings and transmits the received data onto the second portion of the respective ring.

17. The apparatus of claim 11, wherein the node is adapted to communicate data over a four linear buses.

18. The apparatus of claim 17, wherein the node comprises four drivers, wherein each driver is designed to communicate over a respective linear bus.

19. The apparatus of claim 17, further comprising a pair of ring interface units, wherein each ring interface is adapted to communicatively couple the node to a respective one of a pair of rings.

20. The apparatus of claim 17, wherein each ring interface unit is adapted to communicatively couple the node to first and second portions of a respective ring.

21. The apparatus of claim 11, wherein the ring interface unit comprises:
a first transceiver for communicating data over a first portion of the ring; and
a second transceiver for communicating data over a second portion of the ring.

22. The apparatus of claim 21, wherein the ring interface unit further comprises:
a first line interface unit for coupling the first transceiver to the first portion of the ring; and
a second line interface unit for coupling the second transceiver to the second portion of the ring.

23. The apparatus of claim 11, wherein the ring interface unit is integrated into the node.

24. An apparatus comprising:
a linear bus node; and
a ring interface unit to communicatively couple the linear bus node to a ring.

25. The apparatus of claim 24, wherein the ring interface unit is adapted to communicatively couple the linear bus node to a plurality of buses.

26. The apparatus of claim 25, wherein each of the plurality of rings communicatively couples the linear bus node to a clockwise neighbor node and a counter-clockwise neighbor node when the linear bus node is communicatively coupled to the respective ring.

27. The apparatus of claim 24, wherein the ring interface unit is integrated into the linear bus node.

28. The apparatus of claim 24, wherein the linear bus node is communicatively coupled to the ring instead of the linear bus.

29. A network comprising:
a ring;
a plurality of nodes, wherein each of the plurality of nodes is adapted to communicate data over a linear bus; and
a plurality of ring interface units, wherein each of the ring interface units communicatively couples a respective node to the ring.

30. A network comprising:
a plurality of nodes, wherein each of the plurality of nodes is adapted to communicate data over a plurality of linear buses; and
a plurality of ring interface units, wherein each of the ring interface units communicatively couples a respective node to a plurality of rings.

31. The network of claim 30, wherein each ring interface unit communicatively couples the respective node to each of the plurality of rings by communicatively coupling the node to first and second portions of each ring.

32. The network of claim 31, wherein when each node transmits data, the respective ring interface unit communicates the data over the first and second portions of each of the plurality of rings.

33. The network of claim 31, wherein when each node is receiving data, the respective ring interface unit receives data from the first and second portions of each of the plurality of rings and forwards the received data to the respective node.

34. The network of claim 31, wherein each ring interface unit receives data on a first portion of each of the plurality of rings and transmits the received data onto the second portion of the respective ring.

35. The network of claim 30, wherein each of the plurality of nodes implements the TTP/A protocol.

36. The network of claim 35, wherein at least one of the plurality of nodes comprises a slave node coupled to at least one transducer.

37. The network of claim 36, wherein the transducer comprises at least one of a sensor and an actuator.

38. The network of claim 35, wherein at least one of the plurality of nodes comprises a master node.

39. The network of claim 38, wherein the master node includes an interface for coupling the node to a TTP/C network, wherein the master node serves as a gateway between the plurality of nodes and the TTP/C network.

40. The network of claim 30, wherein each of the ring interface units is integrated into a respective node.

41. The network of claim 30, wherein each ring interface unit communicatively couples a respective node to the plurality of rings instead of the plurality of linear buses.

42. The network of claim 30, wherein the network comprises a peer-to-peer network.

43. A network comprising:
a plurality of linear bus nodes; and
a plurality of ring interface units;
wherein each of the linear bus nodes is communicatively coupled to a ring using at least one of the plurality of ring interface units.

44. A network comprising:
a plurality of linear bus nodes; and
a plurality of ring interface units;
wherein each of the linear bus nodes is communicatively coupled to each of a plurality of rings using at least one of the plurality of ring interface units.

45. The network of claim 44, wherein each ring communicatively couples each of the plurality of linear bus nodes to a clockwise neighbor linear bus node and a counter-clockwise neighbor linear bus node.

46. The network of claim 44, wherein each ring interface unit is integrated into a respective linear bus node.

47. The network of claim 44, wherein each of the linear bus nodes is communicatively coupled to the plurality of rings instead of a plurality of linear buses.

48. An apparatus comprising:
first means for communicating data over a linear bus; and
second means for coupling the first means to a ring.

49. An apparatus comprising:
first means for communicating data over a plurality of linear buses; and
second means for coupling the first means to a plurality of rings.

50. The apparatus of claim 49, wherein the second means comprises means for coupling the first means to the plurality of rings instead of the plurality of linear buses.
